(19) United States
(12) Patent Application Publication
(10) Pub. No.: US 2016/0145153 A1
(43) Pub. Date: May 26, 2016

(54) GREEN BRICK AND METHOD FOR PRODUCING THE SAME

(71) Applicants: Mei-Li Hou, (US); Tsai-Chu Huang, (US)

(72) Inventors: CHAO-LUNG HWANG, Taipei City (TW); Trong-Phuoc Huynh, Taipei City (TW)

(21) Appl. No.: 14/627,140

(22) Filed: Feb. 20, 2015

(30) Foreign Application Priority Data
Nov. 21, 2014 (TW) 103220735

(51) Int. Cl. C04B 7/14; C04B 14/00; C04B 9/20

(52) U.S. Cl. CPC C04B 7/14; C04B 9/20; C04B 14/005

(57) ABSTRACT

A green brick includes a brick body that is further consisted of a lubrication adhesive and an aggregate. The lubrication adhesive and the aggregate are mixed and then applied by a specific pressure so as to form the brick body. The lubrication adhesive is consisted of an activating solution and a binder. The binder is blast furnace slag, agricultural waste ashes, or a combination of the blast furnace slag and the agricultural waste ashes. Thus, the blast furnace slag and the agricultural waste ashes that are originally to be discarded are now recycled to form the green brick, such that the environmental pollution caused thereby can be reduced to a minimum.

This application claims the benefit of Taiwan Patent Application Serial No. 103220735, filed Nov. 21, 2014, the subject matter of which is incorporated herein by reference.

### BACKGROUND OF INVENTION

1. Field of the Invention

The invention relates to a green brick and a method for producing the same, and more particularly to the green or environment brick and the accompanying method that use the blast furnace slag, the agricultural waste ashes and the sands to manufacture the brick body for the environment-protection purpose.

2. Description of the Prior Art

Manufacturing of a conventional brick is first to mould the clay into a rectangular block, and then the rectangular block is sent to a kiln for baking so as to sinter the rectangular clay block into a brick. However, for the conventional method for producing the bricks requires tremendous land and energy consumptions, thus the conventional brick industry is gradually eliminated.

To conserve the agricultural lands and environment, and to avoid the aforesaid harsh circumstance to the conventional brick industry, the related manufacturers gradually introduce some new materials to produce the brick that need not experience the sintering process. These new materials for mixing cements to produce bricks include shale, fly ashes, sands or construction wastes.

Nevertheless, though the sinter-free bricks made of the aforesaid new materials may reduce the consumption of resources in lands and energy, yet exploiting of the cements may also hurt the environment. Thus, the shortcomings also exist in producing these sinter-free bricks.

In most of major agricultural countries, it is common that a huge amount of agricultural wastes such as rice husks, rice stems, wheat husks or wheat stems would be generated. A general way to handle these agricultural wastes is to burn them into ashes and then to directly discard or recycle as a part of fertilizers. One fact is that these agricultural wastes never be used to produce the sinter-free bricks. It is the incentive of the present invention to recycle the agricultural wastes as a part of materials for producing the sinter-free brick, such that the environmental protection can be substantially enhanced.

### SUMMARY OF THE INVENTION

Accordingly, it is the primary object of the present invention to provide a green brick (or environment friendly brick) that uses the agricultural waste ashes, the blast furnace slag and the sands as part of materials to produce a sinter-free and environment-friendly brick.

In the present invention, the green brick comprises a brick body consisted of a lubrication adhesive and an aggregate. The lubrication adhesive and the aggregate are mixed together to form a mixture, and the mixture is then applied by a specific pressure so as to form the brick body.

In one embodiment of the present invention, the method for producing the green brick comprises the following steps.

In one step of this embodiment, a binder and an alkaline solution are mixed to form a lubrication adhesive.

In another step of this embodiment, an aggregate and the lubrication adhesive are mixed to form a mixture, then the mixture of the aggregate and the lubrication adhesive is placed in a mold, and a specific pressure is applied to the mixture in the mold so as to form a brick body.

In another embodiment of the present invention, the method for producing the green brick comprises the following steps.

In one step of this embodiment, blast furnace slag, agricultural waste ashes and an NaOH are mixed and then added by a water so as to form a lubrication adhesive.

In another step of this embodiment, an aggregate and the lubrication adhesive are mixed to form a mixture, then the mixture of the aggregate and the lubrication adhesive is placed in a mold, and a specific pressure is applied to the mixture in the mold so as to form a brick body.

In one further embodiment of the present invention, the method for producing the green brick comprises the following steps.

In one step of this embodiment, blast furnace slag, agricultural waste ashes, an NaOH and a mixture are mixed and then added by a water, the combination of all the aforesaid matters are well mixed and placed into a mold, a specific pressure is therefore applied to the combination so as to form a brick body.

The lubrication adhesive of the present invention is consisted of the activating solution and the binder. The agricultural waste ashes, the blast furnace slag or a combination of the agricultural waste ashes and the blast furnace slag for the binder in the present invention can contribute a lot to these ashes that are used to be discarded and that caused significant environmental pollution. Namely, by providing the present invention to recycle the agricultural waste ashes and the blast furnace slag, the agricultural waste ashes and the blast furnace slag can no more affect the environment by pollutions.

All these objects are achieved by the green brick and the method for producing the same described below.

### BRIEF DESCRIPTION OF THE DRAWINGS

The present invention will now be specified with reference to its preferred embodiment illustrated in the drawings, in which:

FIG. 1 is a schematic perspective view of the preferred green brick in accordance with the present invention;

FIG. 2 shows relationship between the compressive strength and the time for the green bricks of the present invention to undergo compression tests;

FIG. 3 shows relationship between the flexural strength and the time for the green bricks of the present invention to undergo bending tests; and

FIG. 4 shows relationship between the density of the brick body and the content percentage of the agricultural waste ashes in accordance with the present invention.

### DESCRIPTION OF THE PREFERRED EMBODIMENT

The invention disclosed herein is directed to a green brick and a method for producing the same. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

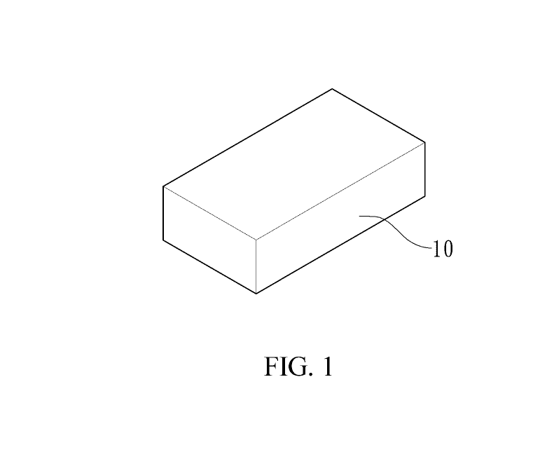

Referring now to FIG. 1, the green brick of the present invention includes a brick body 10, which the brick body 10 is consisted of a lubrication adhesive and an aggregate. The brick body 10 can be shaped as a rectangular block, a cylindrical block or a block having at least a hole.

By varying the weight percentages of the lubrication adhesive and the aggregate, various embodiments with different combinations can be obtained as follows.

In one embodiment of the present invention, the lubrication adhesive is consisted of a binder and an activating solution. The binder shares about a 25% weight percentage of the brick body 10. The binder is a mixture of the blast furnace slag and the agricultural waste ashes, in which the blast furnace slag shares about a 15% weight percentage of the brick body 10, while the agricultural waste ashes shares about a 10% weight percentage of the brick body 10. The agricultural waste ashes can be the burn-down ashes of the rice husks, the rice stems, the wheat husks or the wheat stems.

The activating solution is an alkaline solution, and shares about a 12% weight percentage of the brick body 10. The alkaline solution is an NaOH solution mixed by the water and the NaOH, in which the NaOH shares about a 10% weight percentage of the brick body 10, while the water shares about a 2% weight percentage of the brick body 10.

The aggregate are the sands, and shares about a 63% weight percentage of the brick body 10.

In another embodiment of the present invention, the binder of the lubrication adhesive shares about a 24% weight percentage of the brick body 10. The blast furnace slag share about a 14% weight percentage of the brick body 10. The agricultural waste ashes share about a 10% weight percentage of the brick body 10.

The activating solution shares about a 16% weight percentage of the brick body 10. The NaOH shares about a 9% weight percentage of the brick body 10, while the water shares about a 7% weight percentage of the brick body 10.

The aggregate shares about a 60% weight percentage of the brick body 10. The aggregate is consisted of the sands and the agricultural waste ashes, in which the sands share about a 42% weight percentage of the brick body 10, while the agricultural waste ashes share about a 18% weight percentage of the brick body 10.

In a further embodiment of the present invention, the blast furnace slag of the lubrication adhesive share about a 23% weight percentage of the brick body 10.

The activating solution shares about a 17% weight percentage of the brick body 10. The NaOH shares about a 9% weight percentage of the brick body 10. The water shares about a 8% weight percentage of the brick body 10.

The aggregate shares about a 60% weight percentage of the brick body 10. The aggregate is consisted of the sands and the agricultural waste ashes, in which the sands share about a 42% weight percentage of the brick body 10, while the agricultural waste ashes share about a 18% weight percentage of the brick body 10.

In also a further embodiment of the present invention, the agricultural waste ashes of the lubrication adhesive share about a 21% weight percentage of the brick body 10.

The activating solution shares about a 17% weight percentage of the brick body 10. The NaOH shares about a 8% weight percentage of the brick body 10. The water shares about a 9% weight percentage of the brick body 10.

The aggregate shares about a 62% weight percentage of the brick body 10. The aggregate is consisted of the sands and the agricultural waste ashes, in which the sands share about a 43% weight percentage of the brick body 10, while the agricultural waste ashes share about a 19% weight percentage of the brick body 10.

In summary, the binder of the lubrication adhesive shares about a 21˜25% weight percentage of the brick body 10. The aggregate shares about a 60˜63% weight percentage of the brick body 10. The NaOH of the lubrication adhesive shares about a 8˜10% weight percentage of the brick body 10.

In the present invention, the method for producing the green brick can have the following steps.

In the first step of the method, the aforesaid agricultural waste ashes are mixed with the blast furnace slag so as to form an ash mixture (i.e. the binder). Then, the binder is added and thus mixed into an alkaline solution to form the lubrication adhesive. For example, the blast furnace slag include SiO₂ (Si⁴⁺) and Al₂O₃ (Al³⁺). The agricultural waste ashes include silicon ions (Si⁴⁺). The alkaline solution is to activate Si⁴⁺ and the Al³⁺ (aluminum ion) so as to formulate the lubrication adhesive.

In the second step of the method, the aggregate is mixed with the lubrication adhesive to form a mixture, and the mixture is then moved into a mold. By applying a specific pressure upon the mixture of the aggregate and the lubrication adhesive in the mold, a brick body 10 with a shape corresponding to the mold is thus formed. For example, if the aggregate includes only the sands, then the sands perform as the skeleton of the brick body 10. If the aggregate includes both the sands and the agricultural waste ashes, then the sands act as the skeleton of the brick body 10, while the agricultural waste ashes act as the filler of the brick body 10 for providing the semi-product the required silicon ions so as to reduce the total weight of the brick body 10 and the carbon footprint of the discarded agricultural waste ashes with respect to the environment pollutions.

In the aforesaid first step, various aspects of the embodiments can be included.

In one embodiment, the blast furnace slag and the alkaline solution are mixed to form a mixture, and the mixture is further mixed with the agricultural waste ashes so as to form the lubrication adhesive.

In one embodiment, the blast furnace slag, the agricultural waste ashes and the NaOH are mixed together, and then a water is added in so as to form the lubrication adhesive.

In the aforesaid second step, various aspects of the embodiments can be included.

In one embodiment, the blast furnace slag, the agricultural waste ashes, the NaOH and the aggregate are mixed, and further a water is added in to form a mixture. The mixture is then injected into a mold and is depressed inside the mold so as to form a brick body in the mold. The aggregate herein can be the sands or a mixture of the sands and the agricultural waste ashes.

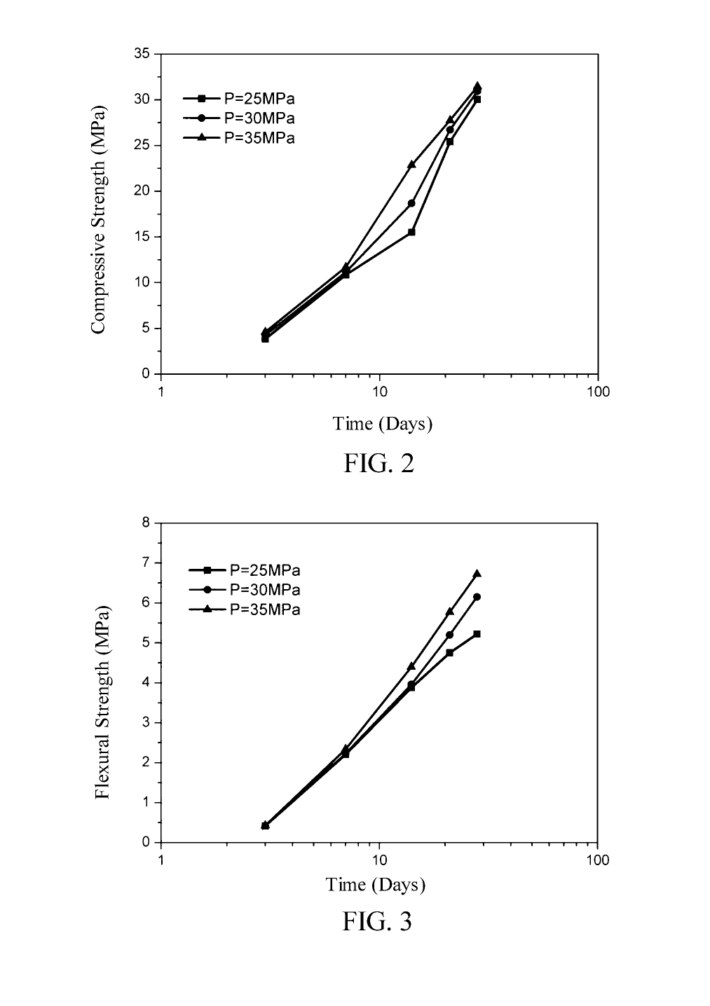

Referring now to FIG. 2, a brick body 10 produced in accordance with the aforesaid material combinations and the method is moved to experience a compressive test. As shown, three types of curves are illustrated in FIG. 2 to stand for the bearing pressures of 35 MPa, 30 MPa and 25 MPa upon the brick body 10. It is shown that the brick body 10 can bear a respective compressive pressure within a specific time period.

Referring now to FIG. 3, a brick body 10 produced in accordance with the aforesaid material combinations and the method is moved to experience a bending test. As shown, three types of curves are illustrated in FIG. 2 to stand for the bearing pressures of 35 MPa, 30 MPa and 25 MPa upon the brick body 10. It is shown that the brick body 10 can bear a respective flexural pressure within a specific time period.

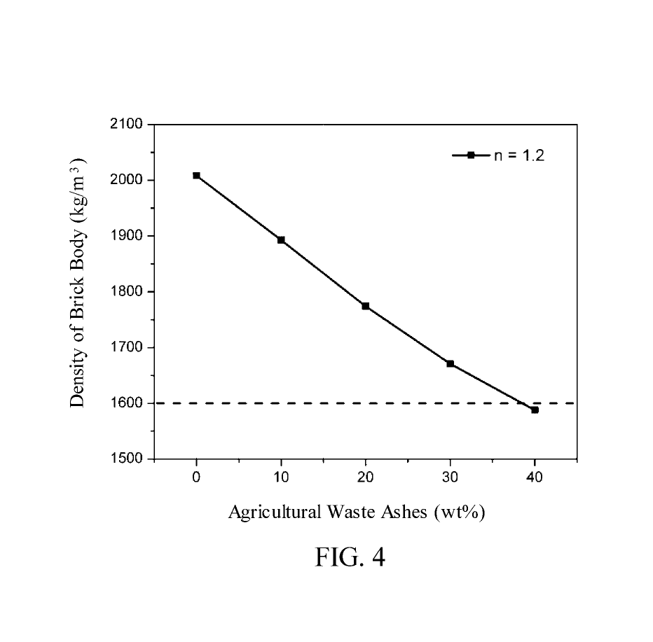

Referring now to FIG. 4, the density change of the brick body 10 with the aggregate having various percentages of the agricultural waste ashes is shown. As shown, in the case that the aggregate does not include the agricultural waste ashes, the brick body 10 would have a density of about 2000 kg/m³. As the weight percentage of the agricultural waste ashes increased, the density of the brick body 10 would achieve a density of about 1600 kg/m³.

In summary, as the aluminum ions or the silicon ions of the binder are combined with the activating solution, the aluminum ions or the silicon ions would be stimulated by the activating solution so as to provide the binder the required viscosity and lubricity, and thus the granulars of the aggregate would be bound firmly, and the interior friction would be thereby reduced.

In addition, the agricultural waste ashes, the blast furnace slag or a combination of the agricultural waste ashes and the blast furnace slag for the binder in the present invention can contribute a lot to these ashes that are used to be discarded and that caused significant environmental pollution. Namely, by providing the present invention to recycle the agricultural waste ashes and the blast furnace slag, the agricultural waste ashes and the blast furnace slag can no more affect the environment by pollutions.

While the present invention has been particularly shown and described with reference to a preferred embodiment, it will be understood by those skilled in the art that various changes in form and detail may be without departing from the spirit and scope of the present invention.

What is claimed is:

1. A green brick, comprising:
a brick body, consisted of a lubrication adhesive and an aggregate;
wherein a mixture of the lubrication adhesive and the aggregate is applied by a specific pressure so as to form the brick body.

2. The green brick of claim 1, wherein the lubrication adhesive has a binder sharing about a 21˜25% weight percentage of the brick body, and the aggregate shares about a 60˜63% weight percentage of the brick body.

3. The green brick of claim 2, wherein the lubrication adhesive has an activating solution, and the activating solution is a alkaline solution having an NaOH sharing about a 8˜10% weight percentage of the brick body.

4. The green brick of claim 1, wherein the lubrication adhesive has a binder and an activating solution, the binder sharing about a 25% weight percentage of the brick body, the activating solution being an alkaline solution sharing about a 12% weight percentage of the brick body, the aggregate sharing about a 63% weight percentage of the brick body.

5. The green brick of claim 3, wherein the binder is consisted of blast furnace slag and agricultural waste ashes, the blast furnace slag sharing about a 15% weight percentage of the brick body, the agricultural waste ashes sharing about a 10% weight percentage of the brick body, the agricultural waste ashes being generated by burning down at least one of rice husks, rice stems, wheat husks and wheat stems, the aggregate being sands, the alkaline solution having an NaOH sharing about a 10% weight percentage of the brick body.

6. The green brick of claim 1, wherein the lubrication adhesive has a binder and an activating solution, the binder sharing about a 24% weight percentage of the brick body, the activating solution being an alkaline solution sharing about a 16% weight percentage of the brick body, the aggregate sharing about a 60% weight percentage of the brick body.

7. The green brick of claim 6, wherein the binder is consisted of blast furnace slag and agricultural waste ashes, the blast furnace slag sharing about a 14% weight percentage of the brick body, the agricultural waste ashes sharing about a 10% weight percentage of the brick body, the agricultural waste ashes being generated by burning down at least one of rice husks, rice stems, wheat husks and wheat stems, the aggregate consisting sands and the agricultural waste ashes, the sands sharing about a 42% weight percentage of the brick body, the agricultural waste ashes sharing about a 18% weight percentage of the brick body, the alkaline solution having an NaOH sharing about a 9% weight percentage of the brick body.

8. The green brick of claim 1, wherein the lubrication adhesive has a binder and an activating solution, the binder sharing about a 23% weight percentage of the brick body, the activating solution being an alkaline solution sharing about a 17% weight percentage of the brick body, the aggregate sharing about a 60% weight percentage of the brick body.

9. The green brick of claim 8, wherein the binder consists blast furnace slag sharing about a 23% weight percentage of the brick body, the alkaline solution having an NaOH sharing about a 9% weight percentage of the brick body, the aggregate consisting sands and the agricultural waste ashes, the sands sharing about a 42% weight percentage of the brick body, the agricultural waste ashes sharing about a 18% weight percentage of the brick body, the agricultural waste ashes being generated by burning down at least one of rice husks, rice stems, wheat husks and wheat stems.

10. The green brick of claim 1, wherein the lubrication adhesive has a binder and an activating solution, the binder sharing about a 21% weight percentage of the brick body, the activating solution being an alkaline solution sharing about a 17% weight percentage of the brick body, the aggregate sharing about a 62% weight percentage of the brick body.

11. The green brick of claim 10, wherein the binder consists agricultural waste ashes sharing about a 21% weight percentage of the brick body, the alkaline solution having an NaOH sharing about a 8% weight percentage of the brick body, the aggregate consisting sands and the agricultural waste ashes, the sands sharing about a 43% weight percentage of the brick body, the agricultural waste ashes sharing about a 19% weight percentage of the brick body, the agricultural waste ashes being generated by burning down at least one of rice husks, rice stems, wheat husks and wheat stems.

12. A method for producing a green brick, comprising the steps of:
mixing a binder and an alkaline solution so as to form a lubrication adhesive; and
mixing an aggregate and the lubrication adhesive to form a mixture to be placed into a mold and to be applied thereupon by a specific pressure so as further to form a brick body in the mold.

13. The method for producing a green brick of claim 12, wherein the binder shares about a 21˜25% weight percentage of the brick body, the binder having blast furnace slag and agricultural waste ashes by mixing, the aggregate shares about a 60˜63% weight percentage of the brick body, the alkaline solution having an NaOH sharing about a 8˜10% weight percentage of the brick body, the agricultural waste ashes being generated by burning down at least one of rice husks, rice stems, wheat husks and wheat stems, the aggregate being one of sands and a combination of the sands and the agricultural waste ashes.

14. A method for producing a green brick, comprising the steps of:
mixing blast furnace slag, agricultural waste ashes and a NaOH, and then adding in a water to form a lubrication adhesive;
mixing an aggregate and the lubrication adhesive to form a mixture, further placing the mixture of the aggregate and the lubrication adhesive into a mold, and then applying a specific pressure upon the mixture so as to form a brick body in the mold.

15. The method for producing a green brick of claim 14, wherein the blast furnace slag and the agricultural waste ashes are mixed to form a binder, the binder sharing about a 21˜25% weight percentage of the brick body, the aggregate shares about a 60˜63% weight percentage of the brick body, the NaOH sharing about a 8˜10% weight percentage of the brick body, the agricultural waste ashes being generated by burning down at least one of rice husks, rice stems, wheat husks and wheat stems, the aggregate being one of sands and a combination of the sands and the agricultural waste ashes.

16. A method for producing a green brick, comprising the steps of:
mixing blast furnace slag, agricultural waste ashes, a NaOH and a mixture, then adding in a water, placing into a mold, and applying a specific pressure to form a brick body.

17. The method for producing a green brick of claim 16, wherein the blast furnace slag and the agricultural waste ashes are mixed to form a binder, the binder sharing about a 21˜25% weight percentage of the brick body, the aggregate shares about a 60˜63% weight percentage of the brick body, the NaOH sharing about a 8˜10% weight percentage of the brick body, the agricultural waste ashes being generated by burning down at least one of rice husks, rice stems, wheat husks and wheat stems, the aggregate being one of sands and a combination of the sands and the agricultural waste ashes.
